(19) United States
(12) Patent Application Publication
(10) Pub. No.: US 2012/0202296 A1
(43) Pub. Date: Aug. 9, 2012

(54) SYSTEM, METHOD, AND APPARATUS FOR MEASURING AFFINITY CONSTANTS

(75) Inventor: Kenneth B. Eisenthal, Ridgewood, NJ (US)

(73) Assignee: The Trustees of Columbia University in the City of New York, New York, NY (US)

(21) Appl. No.: 13/365,130

(22) Filed: Feb. 2, 2012

Related U.S. Application Data
(60) Provisional application No. 61/438,788, filed on Feb. 2, 2011.

(51) Int. Cl. G01N 21/55

(52) U.S. Cl. 436/501; 422/69

(57) ABSTRACT

Nonlinear spectroscopic systems, methods, and apparatuses for measuring affinity constants of molecule-molecule reactions and/or for determining a maximum number of molecule-molecule complexes. Second harmonic generation (“SHG”) or sum-frequency generation is used to probe a sample. A magnitude of a net electric charge at a solid/water interface can be detected and used to determine characteristics of the molecule-molecule complex.

### CROSS-REFERENCE TO RELATED APPLICATIONS

The present application claims the benefit of U.S. Provisional Application No. 61/438,788, filed Feb. 2, 2011, which is incorporated herein by reference in its entirety.

### FEDERALLY SPONSORED RESEARCH AND DEVELOPMENT STATEMENT

The invention was made with government support under Grant/Contract No. CHE-1041980 awarded by the National Science Foundation (“NSF”). The government has certain rights in the invention.

### BACKGROUND

One principle of biochemistry is that biomolecules, such as DNA or proteins, can interact with other biomolecules to form complexes. This interaction of biomolecules (i.e., complexing) with other biomolecules can allow the execution of various processes within organisms.

To gauge the strength of these complexes (i.e., the bonds), an affinity or binding constant of the complex can be measured. An affinity constant characterizes the strength of a biomolecule-biomolecule interaction and may be represented by the ratio of complexed to uncomplexed biomolecules.

Two common methods to measure affinity constants are Surface Plasmon Resonance (“SPR”) and Isothermal calorimetry (“ITC”). Surface Plasmon Resonance and Isothermal calorimetry measure changes in refractive index and heat generated, respectively, upon complexation.

### SUMMARY

The Summary describes and identifies features of some embodiments. It is presented as a convenient summary of some embodiments, but not all. Further the Summary does not necessarily identify critical or essential features of the embodiments, disclosed subject matter, or claims.

The disclosed subject matter relates to measurement of the affinity constants (bonding strength] of molecules, such as biomolecules, including. DNA RNA, proteins, interacting with other biomolecules and small molecules, e.g. drugs, peptides. In embodiments, a disclosed method employs second harmonic SHG, and sum-frequency generation, SFG, to measure the change in the optical signals that occurs when a biomolecule complexes with another biomolecule. In the method, changes in the net charge of the microparticles on complexation, and changes in the nonlinear hyperpolarizability due to the presence of a new molecule complexed with a bound target molecule produce a change in the SHG/SFG signals. Changes in the second order nonlinear susceptibility cause a change in the detected optical signals. In embodiments, the disclosed subject matter employs a laser, a monochromator, a photomultiplier and a computer to interface the data. The methods and systems described may have advantages over surface Plasmon resonance and calorimetry.

In embodiments, one of the two participating biomolecules are attached to nano-micro polymer particle or other composition nano-micro particles which are suspended in water and are effective to increase the area for interactions between the bound biomolecules compared to the use of molecules bound to a planar surface. A solution containing the other biomolecule is conveyed into the optical cell and the SHG and/or SFG signals are collected and directed into a monochromator. Filters may be used in place of a monochromator in alternative embodiments. This system and method provide a commercial opportunity in drug design, exploring treatment methodologies, and diagnostic methods at the biomolecular level. The methods may also be used for the development and quality control in non-biological, organic, semiconductor, metals, or biomolecular industrial manufactures for production of chemical species, agents, drugs, nanoparticles, metals, etc.

The techniques and systems can be used to interrogate the chemistry of microbubbles, media interfaces, membranes, solid-air interfaces, solid-water, and solid-solid interfaces, etc.

In embodiments, the disclosed methods and systems may be employed to measure the affinity constants of biomolecules interacting with other biomolecules or with small molecules, (for example, molecules with MW<1000) by detecting the change in the net electric charge at a solid/water interface when a free biomolecule from the aqueous solution complexes with biomolecules that are bound to the solid side of the interface. DNA, RNA, and most proteins are charged. As a result, there may be a change in the net surface charge upon complex formation. For example, the complexing of an interface bound protein with a free DNA from the solution may result in a substantial change in the net surface charge because DNA is highly charged (−1 for each base pair). The methods may be used to quantify biomolecule-biomolecule interactions based on the magnitude of what is referred to as their affinity constant. The magnitude of the affinity constant is of major importance in that it may be used to characterize the strength of the biomolecule-biomolecule interaction. The affinity constant is defined as the dissociation constant of the complex,

Affinity Constant=K_{d}=(B)(M)/(B−M)

where (B) is the concentration of the biomolecule, (M) is the concentration of the molecule with which it complexes, and (B−M) is the concentration of the complex. The proposed method to measure affinity constants may be employed without the use of labeling of any molecules. It utilizes second harmonic generation, SHG, to probe the biosystem of interest. In SHG the incident light at frequency co-irradiates the system under investigation and can generate light at 2ω, provided certain symmetry restrictions are satisfied. The restriction is that generation of coherent SHG is forbidden in centrosymmetric and isotropic media e.g. centrosymmetric solids, bulk liquids, and gases. On the other hand coherent SHG is allowed at interfaces because interfaces are inherently asymmetric, e.g. at the air/water interface, air above and water below. the forces experienced by interfacial molecules are asymmetric, and the interfacial molecules are oriented, which means that “centrosymmetry” is broken at the interface and SHG is allowed. We can express the interactions of the incident light, at frequency ω, with the interface, which generates light at frequency 2ω by a second order polarization P(2)(2ω) of the interfacial molecules.

E(2ω)∝P⁽²⁾(2ω)=χ⁽²⁾E(ω)E(ω) (1)

where χ⁽²⁾ is the second order susceptibility, which contains all of the information of the interfacial molecules, E(ω) is the incident optical electric field at frequency ω, and E(2ω) is the generated second harmonic field. However, and most importantly for the proposed research, is that if the interface is charged, the “centrosymmetry” of the bulk water is broken, and there is an additional mechanism for generating coherent second harmonic light, E′(2ω). This new mechanism is due to three electric fields inducing a third order polarization P⁽³⁾ in the bulk water molecules. If the three electric fields are from the incident light at frequency ω then third harmonic light at frequency 3ω is generated⁹. However an optical field, E′(2ω), at frequency 2ω can be generated by the third order process if two of the electric fields are the incident optical fields E(ω) at frequency ω, and the third electric field is the static field E₀ created by the charged molecules at the interface.

E′(2ω)∝P⁽³⁾=χ⁽³⁾E(ω)E(ω)E₀ (2)

where χ⁽³⁾ is the third order susceptibility, which is a property of bulk water. The third order polarization is the product of only two optical fields, as seen in Eq. 2. E₀ is a static field, i.e. zero frequency. As a result, the third order polarization of the bulk water can generate coherent second harmonic light, E′(2ω), at the frequency 2ω. The electric field Eo extending into the bulk water, polarizing the water molecules, breaks the “centrosymmetry” of the bulk water. In fact, unlike a second order process, a third order process is not symmetry-forbidden, but rather is allowed in centrosymmetric and isotropic systems such as bulk water. Thus there are two contributions to the third order process, one involves a third order polarizability, α⁽³⁾ and the other is due to a partial alignment of the bulk water molecules. The third order process is sensitive to the static electric field, Eo created by the charged interface. Light at 2ω can be generated in multiple ways: one is by a second order process that is due only to molecules at the interface. Another mechanism is a third order process that is due to bulk water molecules. The total second harmonic field, E(2ω), is the coherent sum of the second harmonic fields generated by the second order and third order mechanisms. In order to include the contributions of all of the water molecules to the third order polarization P⁽³⁾(2ω) Equation 2 is integrated from zero to infinity, which yields the electrostatic potential at the interface, φ₀. Thus Eq. 2 is replaced by Eq. 3.

E′(2ω)∝P⁽³⁾=χ⁽³⁾)E(ω)E(ω)φ₀ (3)

The intensity of the second harmonic light I(2ω) is the signal that is detected, which is,

I(2ω)∝|E(2ω)|²∝|χ⁽²⁾+χ⁽³⁾φ₀|²E(ω)E(ω)E(ω)E(ω) (4)

As should be clear from the present disclosure, in the presence of charges at a water interface, an electric field is generated that extends into the bulk water, thereby polarizing the bulk water molecules. The disclosed subject matter exploits the fact that the magnitude of the interface charge directly affects the strength of the SHG signal. This is used to measure complex formation between charged biomolecules and between a charged biomolecule complexing with a neutral molecule. With the SHG method it is possible to measure the change in the net interface charge that takes place when charged biomolecules, e.g. free DNA from the bulk solution, complexes with the biomolecules that are bound to the interface. The interface to which the target molecules are bound may be, for example, the interface of water with the surface of polymer beads suspended in water. From measurements of the dependence of the SHG intensity on the bulk concentration of the bioanalyte, we obtain the affinity constant, Ka of the bio complex and the maximum number of complexes, Nmax, that can be formed in the system of interest, which most other methods cannot provide. On combining Nmax with the total number of target molecules bound to the interface it is possible to obtain the number of target molecules that are inactive. The method was confirmed by data SHG which is shown in FIG. 4. SHG measurements were carried out of the adsorption of the positively charged protein, cytochrome C, to the negatively charged sulfate groups on the surface of a 1 μm polystyrene sulfate spheres in aqueous solution. Good agreement between theory and experiment is evidenced by the solid line, which is a theoretical fit to the data of FIG. 4. Nine (9) ng of protein was used in the SHG experiments.

A smaller or larger quantity of biomolecules may be used. The size of the polymer beads may be varied as may their solution density, composition as also may be the concentrations of analyte and interface densities of bound biomolecules. Various linkers that bind the biomolecule to the polymer surface may be used which may increase the distance of the biomolecule from the polymer/water interface which may reveal proximity effects.

Polymer beads suspended in water may be decorated with selected target biomolecules. The total surface area of a low density of μm beads that are irradiated with the incident light is much larger than the area irradiated for a planar interface. As a consequence more of the biomolecules bound to the suspended polymer beads may be irradiated and thereby the SHG signal may be increased. In addition to the smaller area irradiated in the planar arrangement, the latter is limited by the fact that the number of complexes formed cannot go beyond the saturation surface density. When saturation is reached for the individual polymer beads the number of beads in solution may be increased, which increases the number irradiated and thus the SHG signal.

The analyte and target molecules do not have to have the opposite sign to form a complex. All that is required is that the net charge at the interface changes when a complex is formed. As a result, the binding will increase the charge at the polymer bead/water interface, which will be manifested by a change in the SHG signal. Whether the SHG increases or decreases is determined by the sign of the interface potential.

The disclosed SHG method uses small quantities and is simple and inexpensive to perform. According to embodiments, the system includes a single femtosecond Ti:sapphire oscillator, a monochrometer or filters to reject all light that is not at the SHG frequency of 2ω, and single photon detection electronics.

The disclosed method embodiments may be used to quantify and further investigate biomolecular interactions, particularly affinity constants, which are central to the determination of the strength of biomolecule-biomolecule interactions. The disclosed methods employ on a nonlinear spectroscopic measurement of interfacial electric charge and second order susceptibility.

Systems, methods, and apparatuses according to various embodiments of the disclosed subject matter can be used, inter alia, for drug discovery, for drug design, to investigate diseases and develop diagnostic methods at the biomolecular level, and for DNA sequencing.

According to embodiments of the disclosed subject matter, systems, methods, and apparatuses measure affinity constants (i.e., binding constants) for any pair of molecules, including organic and inorganic species, in which a net charge is changed upon complexation. A nonlinear spectroscopy technique, such as second harmonic generation (“SHG”) or sum-frequency generation is used to probe the system. Disclosed embodiments also include systems, methods, and apparatuses for determining a maximum number of molecule-molecule complexes as well as for selectively probing a specific biomolecular interaction in the presence of at least one other biomolecular interaction.

### BRIEF DESCRIPTION OF THE DRAWINGS

The accompanying drawings illustrate embodiments of the disclosed subject matter. The disclosed subject matter will be best understood by reading the ensuing specification in conjunction with the drawing figures, in which like elements are designated by like reference numerals, and wherein:

FIGS. 1A and 1B illustrate the structure of a process in which enzyme is used to change the shape of, and cleave, DNA attached to a microparticle surface.

FIG. 1C shows time-resolved SH signals obtained from a reaction of the DNA-coated microparticles with the restriction enzyme EcoR1 at various Mg2⁺ concentrations indicated in each frame.

FIG. 1D is a chart showing a time-resolved SH signal measured when EcoR1 is added to a PSC-DNA solution containing NaCl.

FIG. 1E shows a kinetic trace of SH signal measured upon addition of NaCl after the EcorR1 reaction was completed. The solid line represents the SH jump and decay, the dashed line is the prereaction SH signal level. The solid line shows the drop and recovery of the SH signal.

FIG. 2A is a diagrammatic illustration of a system according to various embodiments of the disclosed subject matter.

FIG. 2B is a diagrammatic representation of a system under test according to various embodiments of the disclosed subject matter.

FIG. 3 is a block diagram of an apparatus according to various embodiments of the disclosed subject matter.

FIG. 4 is a data chart showing SHG intensity versus [cyt C].

FIG. 5 is a block diagram of a method according to various embodiments of the disclosed subject matter.

FIG. 6 is a block diagram of another method according to various embodiments of the disclosed subject matter.

FIG. 7 is a block diagram of a yet another method according to various embodiments of the disclosed subject matter.

FIGS. 8 and 9 show a time resolved plot of second harmonic generated light over a time during which the concentration of a free molecule, Daunomycin, is progressively increased for a surface bound DNA having a recognition sequence (FIG. 8) and a control case where the DNA has no recognition sequence with an affinity for the Daunomycin.

### DETAILED DESCRIPTION

According to embodiments, the disclosed subject matter relate to methods, systems, devices, and kits that may be used for revealing information related to the binding constants, number of active binding sites, or nature of binding, for example, the measurement of affinity or binding constants for one or more binding pairs of molecules (including ions). The embodiments are further applicable where a net charge is changed upon binding. The binding may be a result of the interaction of organic and inorganic species, and is particularly applicable for biomolecules that form complexes with other molecules, especially, but not necessarily, other biomolecules. In examples, one of the molecules is a relatively small molecules (e.g., MW<1000).

In embodiments, a measurement method is performed in the absence of labeling of molecules. That is, the disclosed embodiments include methods in which labeling is unnecessary for the determination of the binding information. According to embodiments of the disclosed subject matter, affinity constants (i.e., binding constants) for any pair of molecules, including organic and inorganic species, in which a net charge is changed upon complexation, is measured. A nonlinear spectroscopy technique, such as second harmonic generation (“SHG”) or sum-frequency generation is used to acquire a signal providing the target binding information. The 2ω signal can be used to determine the number of binding sites, to classify types of alternative complexes formed, and other aspects of a system by combining the second harmonic signal intensity with other information.

Disclosed embodiments also include systems, methods, and apparatuses for determining a maximum number of molecule-molecule complexes as well as for selectively probing a specific biomeolecular interaction in the presence of at least one other biomolecular interaction. The disclosed subject matter has various applications, including but not limited to measurement, process control, quality control, manufacturing, systematic discovery of new materials, drugs or products containing naturally occurring or synthetic materials, and others.

The disclosed subject matter also relates to nonlinear spectroscopic systems, methods, and apparatuses for determining a maximum number of molecule-molecule bonds that are formed, or that can be formed. The disclosure also relates to selectively probing of a specific molecular interaction in the presence of at least one other different molecular interaction.

In embodiments of the disclosed subject matter, an automated system, progressively or stepwise changes an input frequency of a radiation input signal (e.g., a laser) to detect or determine affinity constant data, then analyzing this data, and outputting the data to a computer storage medium and/or a display device. The change of the input frequency may be used to gather a spectrum from a target sample without knowing in advance the precise frequency that provides the strongest signal.

A molecular system under test (e.g., a biosystem) initially can contain free molecules in an aqueous solution and a solid component having one or more molecules bound thereto. The solid component can be a planar surface or a plurality of solid components, such as nano or micro sized beads. A portion (i.e., some, none, or all) of the free molecules from the aqueous solution can bind, or complex, with the one or more bound molecules. Though an aqueous solution is discussed in the embodiments, any suitable solution or liquid can be used.

A change in a net electric charge may occur at a solid/water interface when a free molecule from the aqueous solution complexes with one of the molecules that are bound to the solid side of the interface. In the case of DNA, RNA, and certain proteins, each is charged (e.g., either positively or negatively) and there will be a change in the net surface charge on complex formation. For instance, complexing of an interface-bound protein with a free DNA from the solution can result in a change in the net surface charge because at least the DNA is charged (e.g., −1 for each base pair). In certain cases, the interface-bound protein also may be charged. Upon complexing, a change in the net surface charge can occur.

A change in magnitude of a net electric charge at the solid/water interface can be detected using SHG and measured. Changes in hyperpolarizabilities due to complexation also may be detected and measured. Quantification of molecule-molecule interactions, such as biomolecule-biomolecule interactions, can be based on the magnitude of the interface charge and accordingly based on the strength of a SHG signal post-passage the interface. As indicated above, the strength of the molecule-molecule interaction can be characterized by the magnitude of the affinity or binding constant for the bond.

Second-order spectroscopies, such as second harmonic and sum-frequency generation, produce coherent signals in anisotropic environments such as those found at interfaces. Incident light at frequency ω irradiates a system at the water/solid interface or interfaces and the target system generates light at 2ω. The generation of the SH light can be described by a model in which the incident light induces a second-order polarization, E(2ω), which is proportional to the square of the incident electromagnetic field, E_{ω}, and radiates an electromagnetic field, E_{2ω}, at 2ω. It is expressed as shown in Equation 1 in the Summary section above. Note that χ⁽²⁾, the second-order susceptibility, combines all of the information regarding the interfacial species that are irradiated. It may account for at least, the chemical identity, the electronic and vibrational states, the energies and transition dipole strengths, the number of each species irradiated, and molecular orientations at the interface. These can be used to probe equilibrium and time-dependent phenomena. The total SH intensity is given by,

$${I}_{2 ω} ( total ) = {\sum }_{j} {I}_{2 ω} ( j ) ,$$

where I_{2ω}(j) is proportional to the absolute square of the second harmonic electric field generated by the microparticle j, i.e.,

I_{2ω}(j)˜|E_{2ω}(j)|²

If the interface is charged, as it is in the experiments described here, largely due to the attachment of DNA molecules to the microparticle surface, then there is an additional source of SH light due to the third-order polarization, P⁽³⁾(2ω), of the interfacial species, which is a product of three electric fields given by,

P⁽³⁾(2ω))=χ⁽³⁾E_{ω}E_{ω}E_{static}(r),

where E_{static}(r) is the electric field, predominantly due to DNA, at a distance, r, from the microparticle that polarizes the surrounding molecules, and χ⁽³⁾ is the third-order susceptibility. It is because E_{static}(r) is a zero frequency electric field that the third-order polarization generates light at 2ω. It is primarily the water molecules that are polarized by the interfacial electric field established by the DNA that is attached to the microparticle surface and includes associated interfacial ions. To include the contributions to the third-order polarization, which include water molecules that are near and far from the microparticle, the static field is integrated over all space to give the interfacial electro-static potential, Φ. The total SH field is thus given by

E_{2ω}˜P_{2ω}=χ⁽²⁾E_{ω}E_{ω}+χ⁽³⁾E_{ω}E_{ω}Φ.

which simultaneously describes the interfacial chemistry and the electrostatic properties of the particle and surrounding molecules. DNA is highly charged at physiological pHs, having a charge of −1 per nucleotide. Therefore coupling DNA to a microparticle substantially increases the microparticle surface charge density, which increases the interface static electric field and thereby the contribution of the third-order polarization to the SH signal. Dissociation of cleaved DNA produces a fragment free to diffuse into the bulk solution. The detachment of a 74-bp fragment from the microparticle surface upon reaction with EcoR1 reduces both the number of nucleotides and the charge at the interface, thus resulting in the decay of the SH signal as the reaction proceeds. Changes in the SH signal due to the interactions of DNA with EcoR1 can be directly monitored in situ.

As was confirmed by experiment, at least some of the disclosed embodiments permit the binding and cleavage to be observed without the need for labeled reporter molecules or invasive detection methods. The time-dependent SH field is linearly proportional to the number density of molecules at the particle surface at high electrolyte concentrations because the contribution to the third-order polarization at high electrolyte concentrations can be neglected. At low electrolyte concentration the time-dependent SH signal is more complex, owing to the third-order polarization.

The intensity of the second harmonic light I(2ω), shown below in Equation 5, is the output signal from the system under test that can be detected.

I(2ω)∝|E(2ω)|²∝|χ⁽²⁾+χ⁽³⁾Φ₀|²E(ω)E(ω)E(ω) (5)

Thus the magnitude of the interface charge can directly affect the strength of the SHG signal.

A particular example of how to use the above quantification method and system was experimentally validated as follows. An experimental apparatus was used to measure a time-resolved SH signal that was similar to that described in Yan E C Y, Liu Y, Eisenthal K B (1998) “New method for determination of surface potential of microscopic particles by second harmonic generation.” J Phys Chem B 102:6331-6336 which is hereby incorporated by reference in its entirety. A Princeton Instruments CCD camera was used to acquire light samples. The fundamental laser frequency was centered at 810 nm with approximately 400 mW of average power and a pulse width of approximately 75 femtoseconds (10⁻¹⁵ sec.; fs). There was no evidence of photo damage to the sample as was established in control experiments where the SH signal was observed to be static in time (SI Text). Polystyrene carboxylate (PSC) microparticle-DNA bioconjugate particles were prepared in an analogous way to previous synthetic reports.

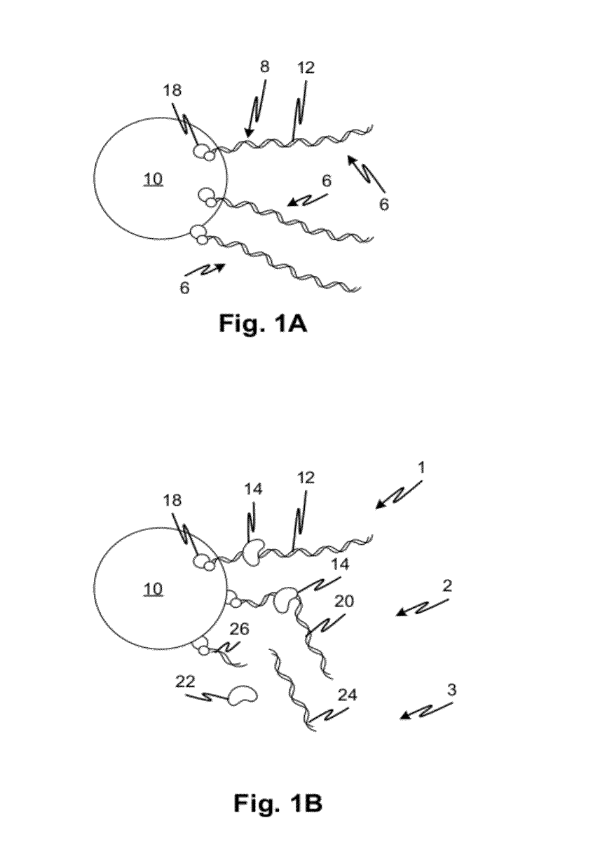

FIG. 1A is a figurative illustration of the resulting particles 6. A biotin binding protein 18, NeutrAvidin (NA), is linked to the PSC surface (diameter ¼ 1.0 μm, Invitrogen). A PSC-NA solution with a concentration of 5.6×109 particles/mL, was suspended in water at pH ¼ 7.5. To this solution ds biotinylated-DNA 12 (90 bp, Integrated DNA Technologies) containing an EcoR1 recognition sequence 8, which is 15 bp from the end attached to the microparticle, was added to a DNA concentration of 0.69 nM and incubated at 55° C. for 1 h. As a control, an analogous DNA sample was prepared in an identical manner with the exception that the control DNA molecule had six base pairs that differed from the EcoR1 recognition sequence. The final particle concentration used in the reactions was 9.3×107 PSC-DNA particles/mL at pH ¼ 7.5. There was no evidence of bead-bead interactions, i.e., no aggregation at this low bead density. The final DNA concentration was 170 pM, leading to a stoichiometric ratio of approximately 1.1×103 DNA/particle, which is a surface coverage of approximately 3.5×102 DNA/μm 2. The Na⁺ concentration in the sample was kept at 2 mM for all experiments except as noted (i.e., where additional NaCl is added). The restriction enzyme was EcoR1. The concentration of the enzyme used in the reaction was 17 μM. The concentration of MgSO4 was varied as indicated below.

The reaction kinetics were obtained from measurements of the SH signal versus time after EcoR1 was added. Negative times correspond to the SH signal prior to injection of EcoR1 with t=0 being the time that the enzyme is added. The SH signals were integrated for 25 s. FIG. 1C shows kinetics traces that are the result of averaging at least two individual experimental runs.

Referring now to FIG. 1B, at 1, the DNA strand 12 is shown in its original state immediately after the attachment of EcoR1 14. Then at 2, EcoR1 changes the conformation of the strand, initially having a bar-shape, to a bent shape 20 as indicated at 2. Finally, as shown at 3, the action of EcoR1 is to cleave the DNA leaving a 74-bp fragment free to diffuse into the bulk solution and an attached 16-bp fragment 26. The free EcorR1 enzyme is indicated at 22.

The reaction kinetics of the restriction enzyme with DNA are strongly dependent on the electrolyte concentration, the size and concentration of the DNA, the concentration of the enzyme, and the temperature at which the reaction is run. Representative kinetic traces of the reaction of EcoR1 with the attached DNA at various Mg 2⁺ concentrations are shown in FIG. 1C for times spanning −750 s-4,500 s. The solid lines are a curvilinear fit to track the general trend as the reaction of DNA with EcoR1 proceeds. Dashed lines represent the prereaction SH signal (intensity) level. The decay times are shown at the various Mg 2⁺concentrations in the respective frames. The prereaction SH signal, was found to be strongly dependent on the Mg 2⁺ concentration, decreasing as the Mg 2⁺ concentration increased. This result is attributed to two factors, both of which reduce the SH signal. One is the binding of Mg 2⁺ to the DNA molecules at the inter-face, which reduces the interfacial charge and thus the interfacial potential, which correspondingly decreases the SH signal. Second, the free Mg 2⁺ in solution acts as an electrolyte that screens the electric field sensed by the bulk water molecules, which lowers the SH signal.

When EcoR1 was added to the reaction cell an abrupt jump in the SH signal was observed, followed by a slow decay over hundreds of seconds. To determine if the jump was due to the binding of EcoR1 to the DNA molecules and not to the surface of the microparticle, a control DNA was used. The control DNA was identical to the DNA that had the recognition sequence, except that the 6-bp EcoR1 recognition sequence has been altered. The control experiment did not show any jump in the SH signal when EcoR1 was added, nor did the amplitude of the SH signal change with time. This indicates that EcoR1 did not induce a structural change to DNA, nor cleave, the DNA molecules that did not have the recognition sequence.

The jump in the SH signal is attributed to an EcoR1-induced conformational change in the DNA structure upon binding of the enzyme to the recognition sequence, which is known to induce a transition from a rod-like shape to a bent conformational state. The bending and unwinding of DNA, by approximately 25°, results in changes of the orientations of the DNA bases relative to one another, which therefore changes the overall absorption strength of the interfacially bound DNA. It is the relative orientations of the bases that determine whether the transition-dipole-transition-dipole interbase interactions result in an increase or decrease in the absorption strength of DNA.

It is known that dsDNA has a smaller absorption cross section, i.e., it is hypochromic, as compared to the absorption cross section of the individual nucleotides or ssDNA. The bending and unwinding of DNA can decrease the parallel stacking of the transition moments and lead to an increased collinear component of the transition-dipole moments that results in a stronger optical absorption. In a similar way, the cancellation of the light induced nonlinear dipole moments of the individual bases can be reduced by conformational changes of DNA, which tends to increase the SH signal and is in accord with the SH measurements. The third-order contribution to the SH must also be considered because upon bending, the electric field associated with the rod-like conformational state of DNA changes. The average static field from the DNA before EcoR1 is added is essentially symmetric about the DNA helical axis and thus the induced polarization of the unbound water molecules on opposite sides of the helical DNA axis largely cancel. These molecules therefore can be regarded as not contributing to the SH signal. However, at the tip of the DNA duplex there would be polarization of the water molecules extending into the bulk medium. Upon bending of the DNA, the average static electric field is no longer radially symmetric with respect to the DNA helical axis; as a consequence there is less cancellation of polarized water molecules, which enhances the third-order polarization and thus results in an increase of the SH signal. In addition to the effects of specific binding of EcoR1 on DNA conformational states, it is noted that information on nonspecific binding is also provided by the SH control experiments.

The SH measurements are consistent with the understanding that the nonspecific binding of EcoR1 to DNA does not result in a distortion of the DNA conformation. Combining these facts with the control experimental result supports the conclusion that the jump in the SH signal is due to the bending and unwinding of DNA induced by specific binding of EcoR1. Thus, neither the nonspecific binding of EcoR1 to locations other than the recognition site, which is known to occur, nor the subsequent lateral diffusion of the enzyme along the DNA strands to reach the recognition sequence, induce the conformational change to DNA that was observed in the SH experiments.

It can be seen in FIG. 1C that the amplitude of the jump in the SH signal increased as the concentration of Mg 2⁺ increased. Because the SH jump occurs before a significant portion of DNA is cleaved, the Mg 2⁺ acts at early times as an electrolyte that screens the repulsive interactions between the neighboring phosphate groups. It thereby facilitates the binding of EcoR1 to DNA and allows for a more facile bending of DNA at the reaction site. Consequently, a better fit of the DNA into the active site of the enzyme (compared to reactions where little or no electrolyte is present) is achieved. To confirm that Mg 2⁺ acts as an electrolyte with respect to the appearance of the SH jump, a separate experiment was performed where NaCl was used in place of Mg 2⁺. Because Mg 2⁺ is needed as a cofactor for the cleavage of DNA by EcoR1 it is expected that replacing Mg 2⁺ with Na⁺ should also result in a sharp jump associated with EcoR1 binding to DNA; however, the SH signal should not decay because cleavage cannot occur when Mg 2⁺ is absent.

The result of this experiment is shown in FIG. 1D, which illustrates that an electrolyte is needed to produce an SH jump and that the amplitude of the jump depends strongly on the electrolyte concentration. Specifically, at an NaCl concentration of 8.50 mM the SH signal jumps by 30% when EcoR1 is added, as compared to a jump of 9.5%, at 2 mM NaCl. These results are consistent with recent experimental and theoretical investigations of the electrostatic interactions between phosphate groups on the DNA backbone and the effect of these interactions on the binding and DNA-bending dynamics of a different restriction endonuclease, namely EcoR1. Additionally, the present results are consistent with experiments that measure DNA flexibility as a function of electrolyte concentration.

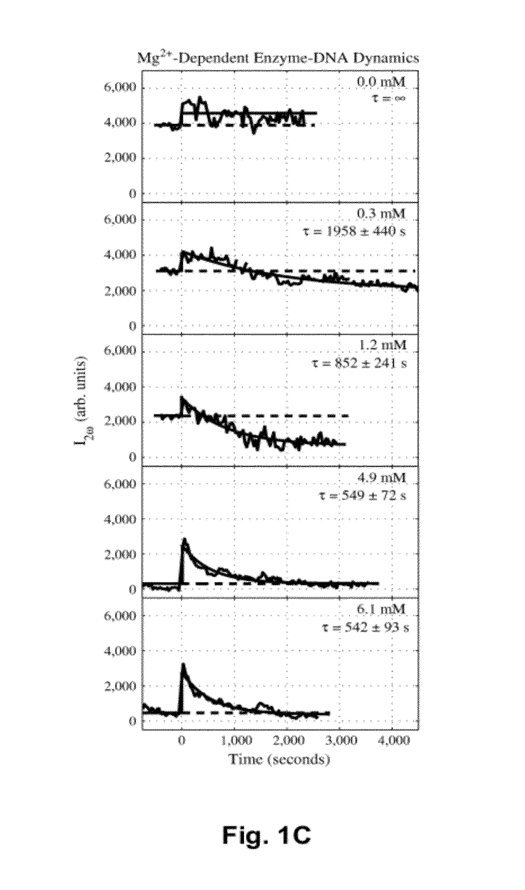

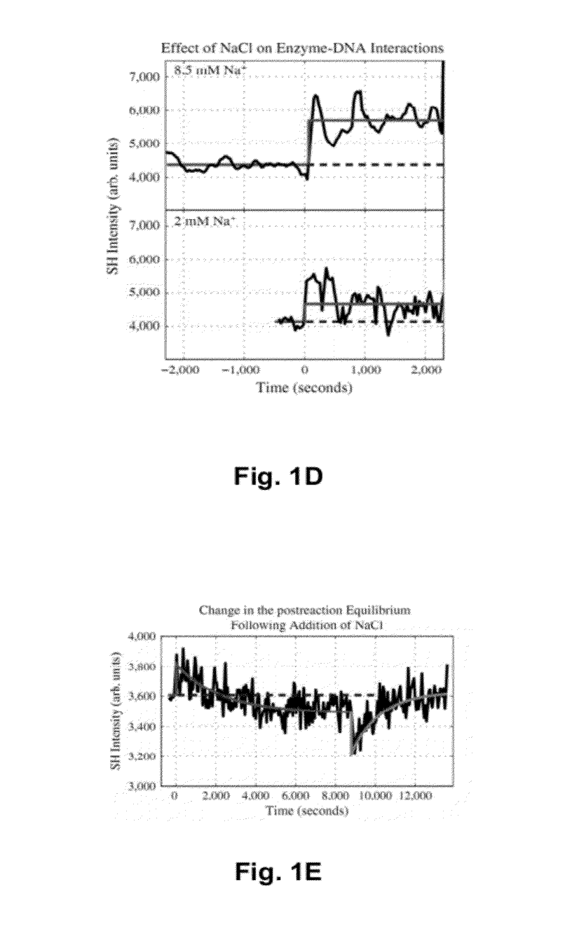

In the presence of Mg 2⁺the observed decay in the SH signal is attributed to the following processes: cleavage of the DNA, dissociation of EcoR1 from DNA, and the diffusion of the 74-bp fragment into the bulk. In the absence of Mg 2⁺ the SH signal does not decay over the span of several thousand seconds (FIG. 2 and FIG. 3). Control experiments successfully indicate that the recognition sequence is necessary for EcoR1 to cleave DNA. Inspection of FIG. 1C shows that the reaction rates are dependent on the concentration of Mg 2⁺ cofactor and range from several hundred to thousands of seconds, in agreement with a range of reported timescales for similar reaction conditions. FIG. 1C shows that at low Mg 2⁺ concentrations the SH signal measured at long times dip below the prereaction level. This result is due to the reduced size of the DNA fragment bound to the interface, which is 16 bp after the cleavage occurs, versus 90 bp before the reaction started. After cleavage, the 74-bp fragment is free in solution and is randomly oriented, and thus does not contribute to the SH signal originating from the microparticles.

In contrast to the aforementioned experiments, it is seen in FIG. 1C that at higher Mg 2⁺ concentration the SH level reaches the intensity that was observed before the reaction was initiated, within experimental uncertainty. In other words the SH signal is essentially the same after the cleavage reaction finishes as it was before any of the DNA was cut. One might not expect the SH signal to return to the same level after the reaction has been completed because a 74-bp fragment has been cleaved from the DNA attached to the microparticle. This feature is addressed hereinbelow.

The behavior of the SH signal long after the EcoR1 reaction can be understood by noting that EcoR1 does not cut DNA into fragments with blunt ends (i.e., no over-hanging bases), but rather cuts the DNA into fragments that can rehybridize via H-bonding and stacking interactions; such DNA fragments are known as sticky-end pairs. The bonds in the phosphate backbone that are cleaved by EcoR1 are not reestablished, but rather base pair complementarity of the sticky ends can reestablish base pairing, which lowers the free energy of the system. The equilibrium between the rehybridized DNA, 90*, and the DNA fragments, namely the attached 16 bp and the free 74 bp,

90 bp⇄74 pb+16 pb.

The equilibrium concentrations of the rehybridized 90* bp, the free 74-bp fragment and the bound 16-bp fragment are strongly dependent on electrolyte concentration because the electrolyte screens the charged fragments, which reduces the repulsive electrostatic interactions between fragments. The increased screening enables the charged DNA strands to get close enough to form the H-bonding and stacking interactions that are necessary for rehybridization. The higher electrolyte concentrations favor rehybridization whereas the lower concentrations favor separation of the two cleaved fragments. Thus, the post reaction concentration of free (74 bp) versus reattached fragments should not be regarded as a reaction end point, but rather as an equilibrium that is dependent on the electrolyte concentration.

To confirm this theory, electrolyte may be added after the reaction has completed, which should result in a time-dependent return to a new equilibrium. NaCl was injected into the reaction cell containing a low concentration of Mg 2⁺, specifically 0.2 mM Mg 2⁺, after the reaction was completed at approximately 9,000 s. The effect of adding NaCl to a final concentration of 9.3 mM resulted in an immediate decrease of the SH signal that was followed by a slow recovery. See FIG. 1E. The signal initially drops due to the increased electrolyte concentration, i.e., greater screening. The SH signal then recovers in time to a final SH level that is greater than the previously observed end point; specifically, it is larger by 3.4±1.6%. The reason for this increase in the SH signal is that the addition of electrolytes results in a shift of the equilibrium between the separated and rehybridized fragments, which favors the rehybridized form. The time it takes to reestablish the new equilibrium condition is roughly 1,200 s. Accordingly, embodiments of the disclosed subject matter include methods and systems for real-time label-free observation of rehybridization dynamics following DNA cleavage.

In a second experiment performed in the presence of 6.1 mM Mg 2⁺, the addition of Na⁺ did not produce an observable immediate drop nor a slow recovery in the SH signal (SI Text), because the third-order polarization contribution to the SH signal is negligible at high electrolyte concentrations. In addition, at this high electrolyte concentration the equilibrium strongly favors the rehybridized form.

Time-resolved second harmonic generation spectroscopy was used to observe the binding of the restriction enzyme EcoR1 to its DNA recognition sequence, followed by cleaving the DNA into a large and small fragment, and also observed the subsequent rehybridization dynamics. A sharp increase in the SH intensity was observed upon addition of EcoR1 to the reaction vessel, which is attributed to conformational changes in the DNA that are induced by the binding of EcoR1. Specifically, the DNA is known to bend and unwind by approximately 25° in the EcoR1-DNA complex relative to its more rod-like conformation in the absence of EcoR1. It was found that the amplitude of the jump in the SH signal is dependent on the presence of electrolytes, which can facilitate the change in the DNA structure by shielding adjacent charges on the DNA backbone when the DNA is in the bent conformational state.

The change in the structure of the DNA that contains the EcoR1 recognition sequence results in a change in the second-order polarization and simultaneously alters the static electric field, which consequently changes the SH signal. In contrast, the SH control experiments indicate the nonspecific binding of EcoR1 to DNA does not induce con-formational changes to DNA. In experiments where Mg 2⁺ was present with recognition DNA, it was observed that Mg 2⁺ acts as both an electrolyte, facilitating the bending of DNA and associated binding of EcoR1, and also as a cofactor that effects the cleavage reaction rates. At lower electrolyte concentrations the cleavage of DNA with EcoR1 produced a free 74-bp DNA fragment and a 16-pb fragment that remains attached to the microparticle, which was seen in experiments where the post reaction SH signal was found to be smaller than its prereaction value. This result was expected because the quantity of DNA that remained bound had been reduced. However at higher electrolyte concentrations the SH signal at long times, within experimental uncertainty, was the same as before the binding and reaction. The explanation of this finding is that there is an equilibrium between the separated DNA fragments and the rehybridized DNA fragments. At higher electrolyte concentrations there is sufficient screening to reduce electrostatic repulsions between the fragments, which shifts the equilibrium population to the rehybridized form of DNA. To confirm this, the equilibrium was perturbed by adding NaCl after the reaction with EcoR1 was completed. A fast decrease followed by a gradual increase in the SH signal that reached an SH signal level that was larger than before adding the NaCl was observed. Following DNA cleavage, the DNA rehybridization was measured in real time and label-free.

In embodiments, the methods and systems employ time-resolved SH spectroscopy, together with biomolecule functionalized microparticles, to probe time-dependent and equilibrium biological processes noninvasively, without labels, and with high sensitivity. The information can be used for research, for quality control, or for manufacturing process control.

FIG. 2A is a block diagram of a system 100 according to various embodiments of the disclosed subject matter. System 100 can be used to determine an affinity constant of a system under test or sample 200, such as shown in FIG. 2. System 100 also can be used to determine a maximum number of molecule-molecule bonds that are formed, or that can be formed, selectively probe a specific molecular interaction in the presence of at least one other different molecular interaction. It may progressively change an input frequency of a radiation input signal (e.g., a laser), receive SH radiation and process to detect or determine affinity constant data, then analyze this data, and output the data to a computer storage medium and/or a processor and display device. The system may also optimize sensitivity for determining affinity constants and/or a maximum number of a maximum number of molecule-molecule complexes.

Generally speaking, light can be used to irradiate the system under test, wherein the light can be reflected to a sensor or detector in order to determine a magnitude of a signal, an SHG signal for example, which is representative of the affinity constant. System 100 can include a radiation source 110, an optical element 120, a detecting element 130, and a processing element 140.

The radiation source 110 may be a laser, such as a femtosecond Ti-sapphire oscillator. Radiation source 110, such as a laser, can output light 112 at a frequency of ω, or may progressively vary the frequency over a range. The output is directed toward optical element 120 to probe a system under test 200 using SHG, for example. In various embodiments, the frequency, i.e., ω, of the laser signal 112 may be changed based on the makeup of the system under test 200, or to determine a component of the system under test 200. For example, ω may be a fundamental frequency of a component of the system under test 200. In various embodiments, the frequency of the output signal (e.g., the output light 112) can be varied, for example, progressively changed across a range of frequencies. Varying the frequency of the output signal may be used to determine a maximum or optimal frequency at which to radiate a given molecule or combination or molecules by identifying peaks in the target SH signal. By scanning over a range of illuminating frequencies and recording SH signals, the presence and concentration of diverse complexes may be identified and quantified.

The optical element 120 can be any suitable optical element, such as a spectroscope. Generally speaking, a spectroscope is an optical device for producing and observing a spectrum of light or radiation from a source. A spectroscope may be comprised of a slit through which the light or radiation passes, a collimating lens, and a prism, such as an Amici prism. Any suitable spectroscope can be used, such as a monochromator or monochromatic illuminator. A monochromator or monochromatic illuminator may include a spectroscope with a slit that can be moved across a spectrum for viewing individual spectral bands. Alternatively, a filter may be used instead of a monochromator or a monochromatic illuminator according to know spectral techniques.

Optical element 120 can contain the system under test 200, or, alternatively, the system under test 200 can b coupled to, or adjacent, optical element 120. In any case, optical element 120 can be arranged or positioned to facilitate nonlinear spectroscopy on the system under test 200, such as second SHG or sum-frequency generation, in order to probe the system under test 200. In various embodiments, optical element 120 can reject all light that is not at the SHG frequency of 2ω.

FIG. 2B is a diagrammatic representation of system under test 200 according to various embodiments of the disclosed subject matter. System under test 200 is a molecular system under test, such as a biosystem, and initially can include free molecules in an aqueous solution and a solid component having one or more molecules bound thereto. The solid component can be a monolithic surface such as a planar surface, or a plurality of solid elements such as microspheres, or any other suitable surface. A portion (i.e., some, none, or all) of the free molecules from the aqueous solution can bind or complex with the one or more bound molecules. Respective interfaces can be associated with each of the molecule-molecule bonds (interface(s) not explicitly shown in FIG. 2B). The system under test 200 can be staged for testing by any suitable means, such as a stage, an enclosure (e.g., a test tube, beaker, or other glass enclosure), etc.

In embodiments, the system under test 200 can be comprised of polymer beads suspended in water that have attached thereto (i.e., are “decorated” with) selected target molecules (e.g., the selected target molecules can be adsorbed to the polymer beads). Neither the target molecules nor the polymer beads is shown explicitly in FIG. 2. Incidentally, though polymer beads are discussed, the beads can be made of any suitable material or combination of materials. Further, the beads can be of any suitable dimension and/or density, such as nano-micro sized 1 μm beads. In various embodiments, the size, configuration, and constitution of the beads may be optimized, for example, based on a molecule or molecules of a given sample.

Use of beads may provide a relatively larger total surface area to be irradiated than using a planar surface. As a consequence more of the bound molecules can be irradiated using beads as compared with a planar surface, thereby increasing the corresponding output SHG signal. Additionally, the relatively smaller area irradiated in the planar arrangement may be limited in that the number of complexes formed may be limited by the saturation surface density of the planar surface. In contrast, when saturation is reached for the individual beads, the number of beads in the solution can be increased, thereby increasing the number of interfaces or potential interfaces irradiated and thus a corresponding SHG signal.

Optionally, the system under test 200 may use linkers that bind the molecule to the solid surface to increase the distance of the molecule from the solid/water interface. Use of such linkers may selected based on associated desired or neutral proximity effects or undesired effects on SH signal may be compensated by further processing such as by computational removal of the undesired influence based on modeling of the system under study.

As discussed above, upon bonding or complexing, a change in a net electric charge can occur at the solid/water interface, and an affinity constant can be determined based on the corresponding SHG signal 122 output from the system under test 200 and the optical element 120.

Detecting element 130 can be of any suitable configuration that provides for capture and quantification of light in the selected frequency range, for example, at or about the predicted or experimentally identified 2H signal frequency. For example, detecting element 130 may constitute a single-photon detection electronics such as a photomultiplier.

Detecting element 130 receives at least a 2ω signal 122 from the optical element 120 and outputs a corresponding signal 132 to processing element 140. Optionally, detecting element 130 can detect a first order mechanism and/or sense a third order mechanism due to charge effects on the bulk water as discussed above. Detection of this third order mechanism may be used to increase sensitivity regarding changes in the SHG signal. Alternatively, a separate detecting or sensing element may be provided to sense or detect the third order mechanism. Signal 132, responsive to, or embodying, the signal 122 can also be sent directly to a computer storage medium. Optionally, processing element 140 may process and analyze the signal 132 and output the data to the computer storage medium and/or an output component, such as a display device or processor and display device.

Processing element 140 can be any suitable mechanism that uses or further processes the SH information, such as a desktop computer, a microprocessor, a PDA, a laptop computer, etc. Further, processing element 140 can be coupled to an output component (not shown) configured for outputting results of calculations performed by the processing element, such as a display or a link to a wireless terminal.

Processing element 140 can include or be coupled to a memory element to store data. Thus, data representative of the signal or signals received from detecting element 130 can be stored in the memory element. Processing element 140 may be configured to compare stored data from the memory element with data received from detecting element 130. For example, data from other known techniques, such as SPR or ITC, can be stored in the memory element and compared to data received from detecting element 130. As another example, data or information from previous, for example a solution pre-complexation may be stored in the memory element and compared with data received from detecting element 130. In various embodiments, such comparing can be used as part of an optimization sequence for optimizing sensitivity and/or accuracy for the SHG signals.

FIG. 3 is a block diagram of an apparatus 300 according to various embodiments of the disclosed subject matter. Apparatus 300 is similar to system 100 discussed above except as noted herebelow. Note, however, that apparatus 300 may be characterized as a self-contained unit including the components and elements shown, as well as their functionality. Not explicitly shown, a system under test or sample such as described above, can be associated with optical element 320 so that it can be probed using SHG.

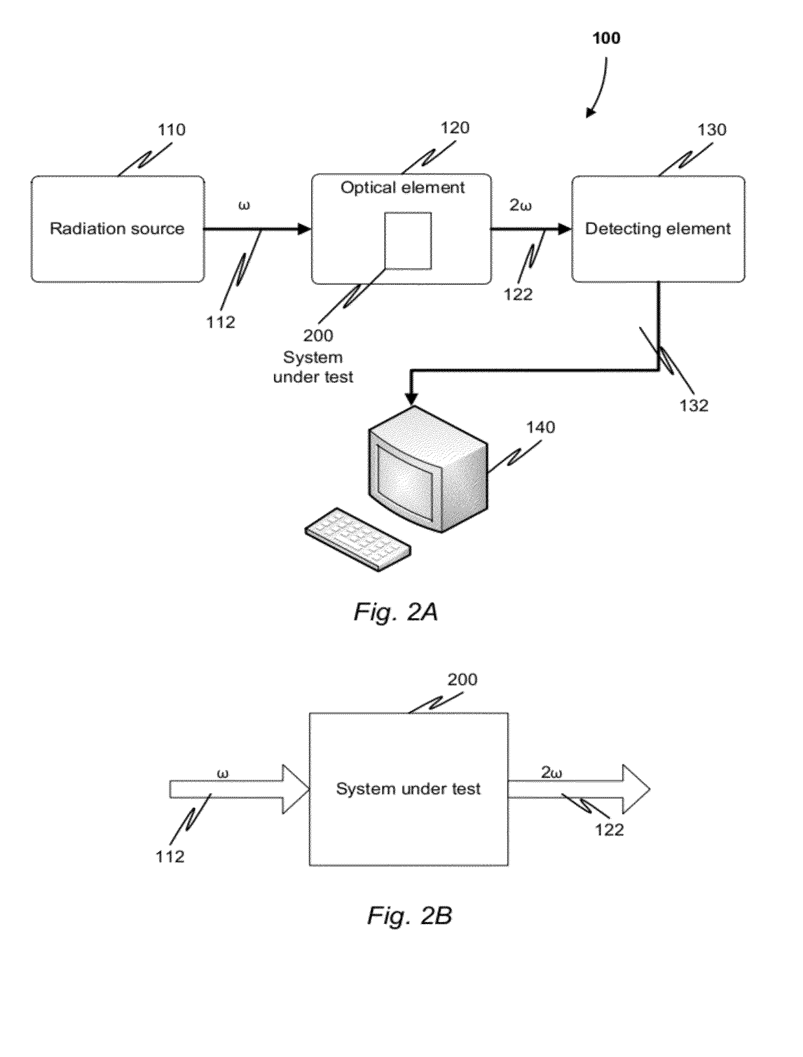

FIG. 4 is a chart showing SHG intensity versus cytochrome-C [cyt C] content.

FIG. 4 shows results of SHG measurements of the adsorption of a positively charged protein, cytochrome C, to negatively charged sulfate groups on the surface of a 1 μm polystyrene sulfate sphere in aqueous solution. The solid line is a theoretical fit to the data points (i.e., the ovals). In various embodiments, 9 ng or less of cytochrome C may be used.

As another example, a biomolecule pair can include the bovine carbonic anhydrase (BCA)-4-carboxybenzenesulfonamide (CBS) pair. Incidentally, this pair's affinity constant has been measured by prior art measurement techniques, such as SPR and ITC. Accordingly, in various embodiments, the standard results of the affinity constant for this pair can be compared to the output of the SHG signal. An inhibitor CBS can act by binding its head group, RSO₂ NH⁻ anion, with the Zn¹¹ ion located in the active site of the enzyme. Note that although BCA has a charge of ˜−3, the CBS inhibitor, which is also negatively charged, −1, form a complex. Thus, as indicated above, the analyte and target biomolecules do not have to have the opposite sign to form a complex. In embodiments, the disclosed subject matter provide a means by which to detect a change in the net charge at the interface when a complex is formed. The binding of CBS to BCA will increase the charge at the polymer bead/water interface to ˜−4, which will be manifested by a change in the SHG signal. Whether the SHG increases or decreases is determined by the sign of the interface potential, which is negative in this case, and by the sign of χ⁽²⁾ with respect to the sign of χ⁽³⁾.

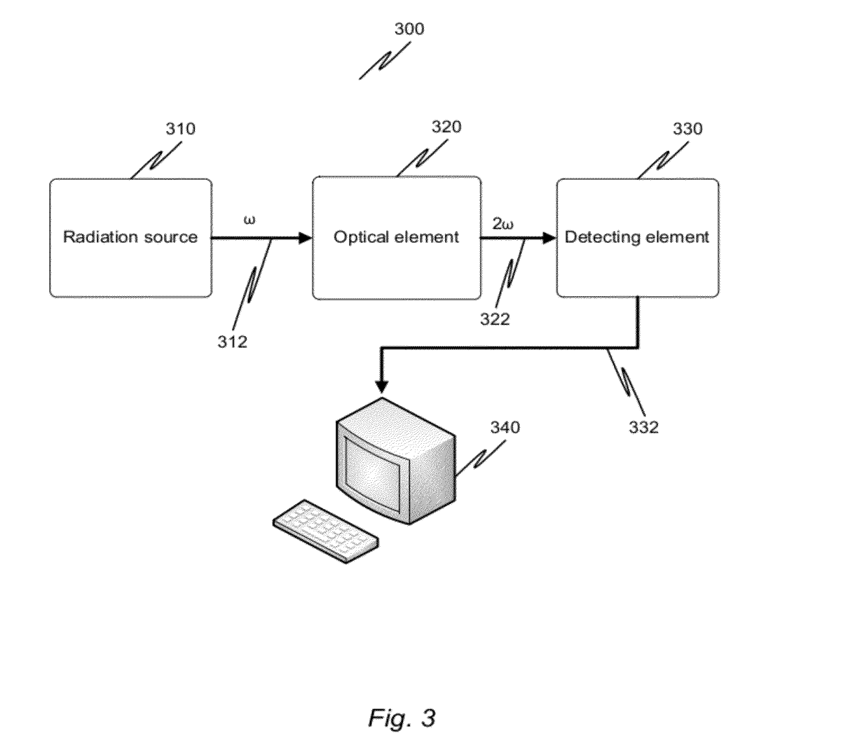

FIG. 5 is a block diagram of a method 500 according to various embodiments of the disclosed subject matter. Generally speaking, method 500 is a non-linear spectroscopic method of measuring an affinity constant. In various embodiments, measurement of the affinity constant is conducted without labeling.

At S504, a plurality of free, charged biomolecules are provided in a solution, such as an aqueous solution. Also provided is a plurality of bound molecules S506. The bound molecules may include target molecules and optionally non-target molecules. The bound molecules can be bound to a solid component, such as polymer beads. The target molecules also may be charged. Alternatively, they may be neutral. The bound molecules can complex or bind with the free molecules S508. The target molecules may alternatively form the surface, or a component of the surface.

The complexes may be probed, using light (e.g., from a laser) at frequency ω, at respective solid/water interfaces S510. The probing can be performed using a nonlinear spectroscopy technique, such as second harmonic generation (“SHG”) or sum-frequency generation (“SFG”). In various embodiments, the probing can include progressively changing input frequency ω.

An affinity constant of the complex or bond can be determined based on a change in net electric charge at the solid water interface. As discussed above, the electrostatic potential is extracted from the SHG signal, for example, so the detected SHG output signal can be used to determine the affinity constant.

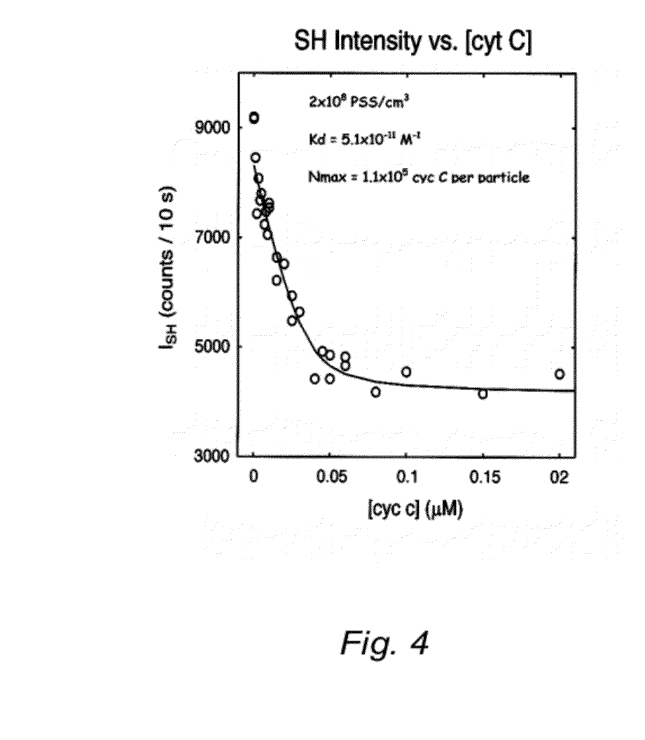

FIG. 6 is another method 600 for measuring an affinity constant of a molecule-molecule bond. Method 600 includes probing a molecular system comprised of a plurality of molecular-molecular bonds using a laser at a first frequency S604, and determining an affinity constant based on a received signal at a second frequency, for example, twice that of the first frequency 606. In various embodiments, the probing can include progressively changing input frequency over a range Δω and receiving a spectrum over a range covering at least 2Δω. The method may include selecting the SH signal as a peak, or other feature, within the received range, which may be done by a signal feature recognition process by a computer.

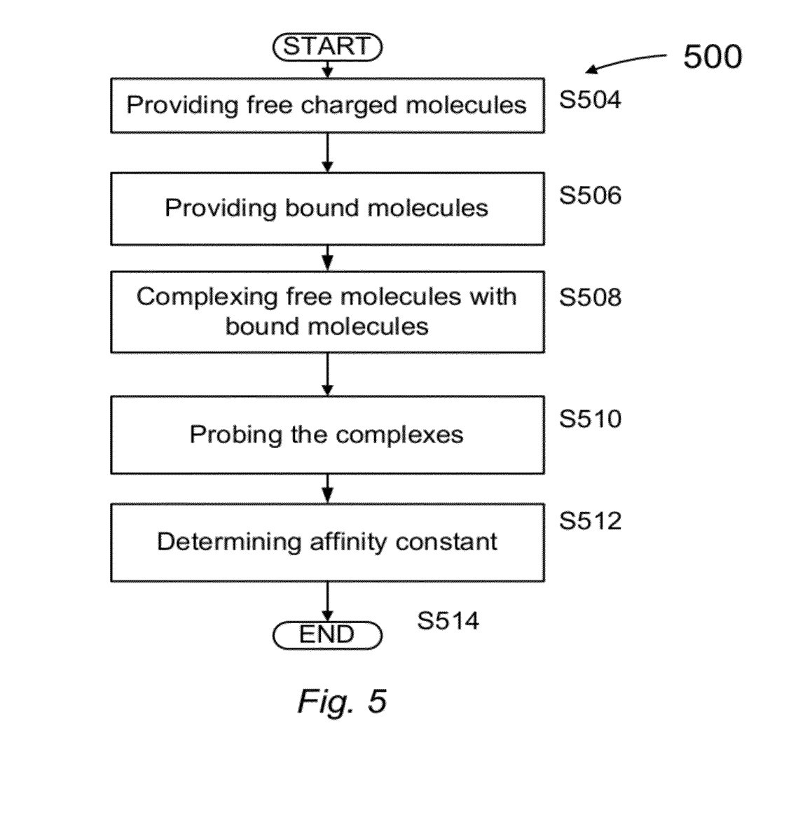

FIG. 7 shows a method 700 to measure a maximum number of bonds or complexes a given system forms. Method 700 includes probing a molecular system comprised of a plurality of molecular-molecular bonds using a laser at a first frequency order to determine an affinity constant S704, for example as described above for method 600. From the determined affinity constant, a maximum number of bonds can be determined that are or can be formed for a given amount of either (B) the concentration of the molecule or the concentration of the molecule with which the first molecule binds or complexes. See, for example, Equation 1 provided above. The quantification may be done automatically by a processor to generate an output signal that is used to display the result or as an output to control, a process that responds to the signal.

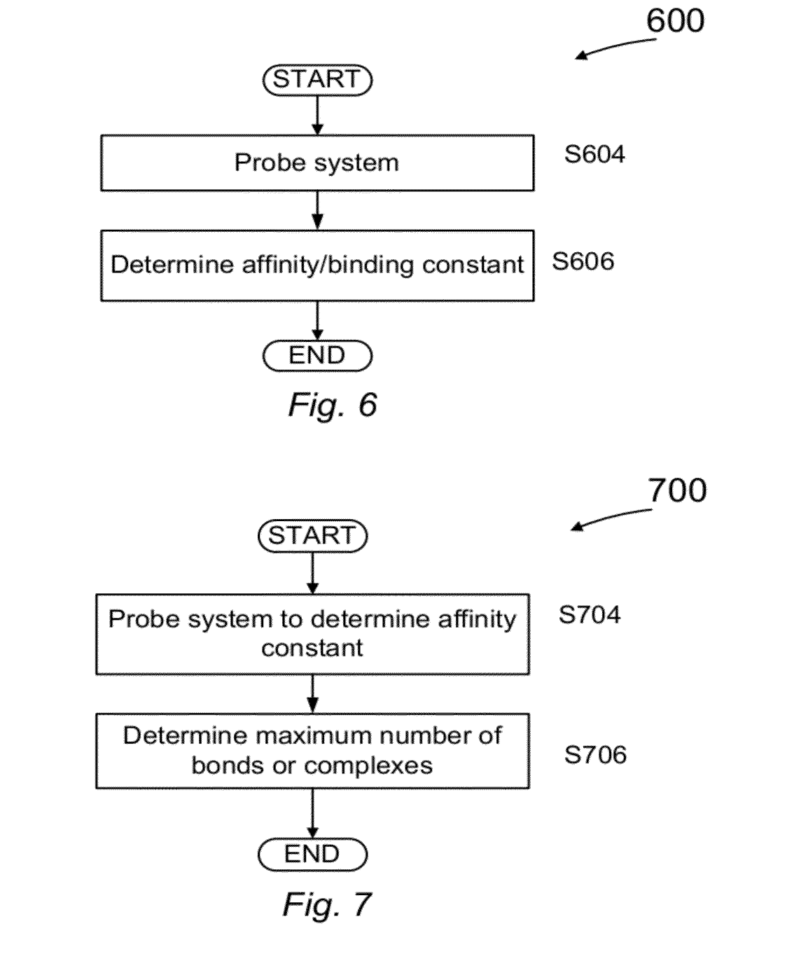

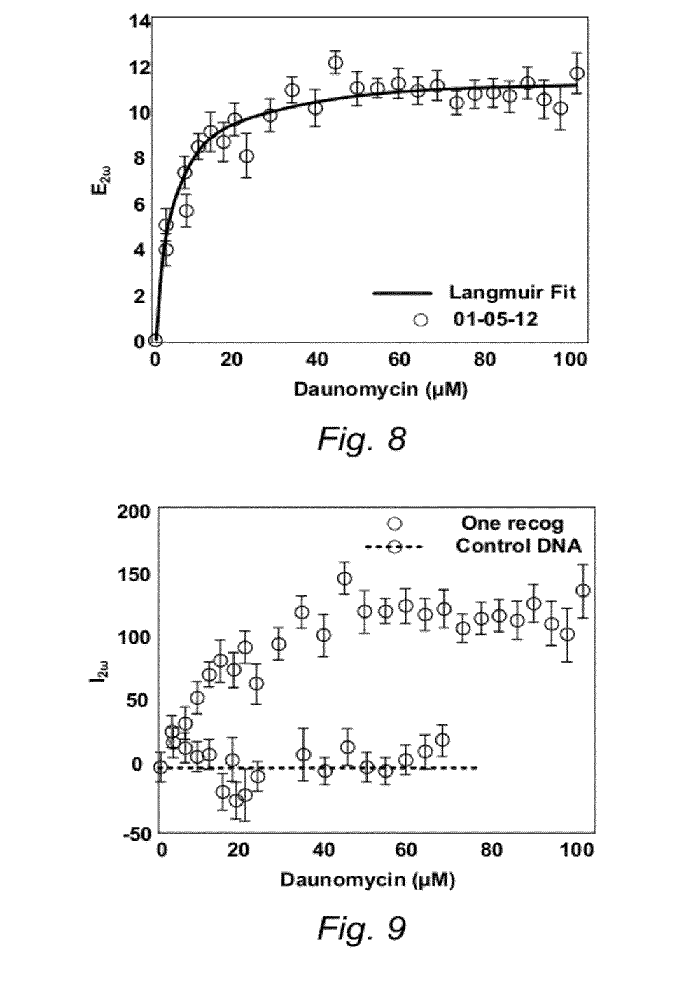

FIGS. 8 and 9 show a time resolved plot of second harmonic generated light over a time during which the concentration of a free molecule, Daunomycin, is progressively increased for a surface bound DNA having a recognition sequence (FIG. 8) and a control case where the DNA has no recognition sequence with an affinity for the Daunomycin. FIG. 8 shows the SHG light as magnitude of electric field for different concentrations of Daunomycin. As can be seen, the curve has the shape corresponding to the Langmuir equation and a fit to a Langmuir curve can provide an affinity constant for the complex. FIG. 9 shows the SHG light intensity and compares a control experiment but is otherwise similar to FIG. 8. The control experiment increased the concentration of Daunomycin for a DNA molecule lacking a recognition sequence for it and therefore represents a case where no complexation occurs.

Another method may involve selectively isolating one particular molecule-pair interaction in the presence of another molecule-pair interaction. This may be done by selectively probing different interfacial molecules by tuning the frequency of the incident light to the resonance frequency of the molecule of interest. Alternatively, this can be done using sum-frequency generation. Optionally, such spectroscopic selectivity can be performed when a layer (e.g., a surface layer) of the system or sample under test is a mixture of different substances. Optionally, different stations of frequencies for isolating one particular molecular-molecular interaction in the presence of other molecular-molecular interactions can be previously determined, for example by progressively changing an input frequency ω.

Yet another method according to disclosed embodiments is for optimizing system under test or sample constituents. For example, this method can involve systematically varying the size of the polymer beads, their solution density, composition, and/or the effects of these various factors on different concentrations of analyte and/or different interface densities of bound molecules. Optionally or alternatively, use of different types (e.g., different lengths) of linkers may be varied.

A disclosed embodiment includes a non-linear spectroscopic method of measuring an affinity constant without labeling. A plurality of free, charged biomolecules in an aqueous solution can be provided, as well as a plurality of bound biomolecules. The bound biomolecules can be bound to respective surfaces of a plurality of polymer beads. The free charged biomolecules can complex with the bound biomolecules and then probed using second harmonic generation (“SHG”). A change in a net electric charge for solid/aqueous interfaces associated with the complexed biomolecules can be detected based on an SHG signal received from the solution. An affinity constant of the complexed biomolecules can be determined based on the detecting. The charged biomolecules can be one of a protein, DNA, and RNA, and the bound molecules can be one of a protein, DNA, and RNA.

Optionally, the determining of the affinity constant can include comparing a detected net electric charge with a previously detected net electric charge. Further, the bound biomolecules are either charged or neutral. Optionally, the free charged biomolecules can have a first negative charge, and the bound biomolecules can have a second negative charge. Optionally, the first and second negative charges are the same.

Disclosed embodiments further include quantifying a maximum number of complexing biomolecules based on said determining the affinity constant. Optionally, the method can further comprise providing a second plurality of free biomolecules in the aqueous solution; providing a second plurality of bound biomolecules; complexing the second free biomolecules with the second bound biomolecules; and selectively probing the first complexed biomolecules using second harmonic generation (“SHG”) in the presence of the second complexed biomolecules. A time-dependent process associated with the complexing also may be determined.

Various embodiments also include a method for determining a molecule-molecule binding constant. An asymmetrical interface associated with molecule-molecule bindings in a molecular system can be probed using a nonlinear spectroscopy technique from the group consisting of second harmonic generation (“SHG”) and sum-frequency generation. A binding constant for the molecule-molecule bindings can be determined based on a change in the net electric charge associated with the asymmetrical interface.

Optionally, at least one of the molecule-molecule partners is a biomolecule, the asymmetrical interfaces are solid/water interfaces associated with complexes formed when free ones of the molecules from an aqueous solution complex with molecules that are bound to a solid side of the solid-water interfaces. Optionally, both of the molecules in the molecule-molecule pair can be charged. Further, in various embodiments, the charges can be different, or they can have different polarities.

The probing can include selective probing based on a fundamental frequency of one of the molecules from the molecule-molecule pair, and determining the binding constant can be based on the aforementioned selective probing. Optionally, a time-dependent process can be determined, wherein the time-dependent process can be one of a binding time and a time for the change in the net electric charge to occur.

Embodiments of the disclosed subject matter also feature a method for selectively isolating one particular biomolecule-biomolecule interaction in the presence of other biomolecule-biomolecule interactions to determine an affinity constant for the one particular biomolecules-biomolecule interaction. Selectively probing of different interfacial biomolecules by tuning a frequency of incident light to an electronic resonance of a molecule of interest for the particular biomolecule-biomolecule interaction, as well as determining an affinity constant for the one particular biomolecules-biomolecule interaction based on the selective probing can be involved.

Optionally, the selectively probing can be performed on a surface layer having a mixture of different substances. Further, in various embodiments, the selective probing can uses second harmonic generation.

The disclosed subject matter also includes embodiments for a method for determining a maximum number or maximum possible number of bonds or complexes. The method can be comprised of probing a system to determine an affinity constant of molecular interactions; and determining a maximum number or maximum possible number of bonds or complexes based on the determined affinity constant. Optionally or alternatively, the probing can include detecting a change in a net electric charge at a solid/water interface when a free biomolecule from an aqueous solution complexes with biomolecules that are bound to a solid side of the interface. Optionally or alternatively, the probing can include using second harmonic or sum-frequency generation (“SFG”) to measure a change in optical signals that occurs when a biomolecule complexes with another biomolecules.

Embodiments of the disclosed subject matter also include a system comprising: means for providing light at a first frequency; means for outputting light at a second frequency different from the first frequency; means for detecting the light at the second frequency; and means for determining an affinity constant of complexed biomolecules at a solid/aqueous interface based on an output signal received from said means for detecting. Optionally, the means for outputting light at the second frequency can be a laser, and may not output light at any other frequency. The second frequency can be twice the frequency of the first frequency. The means for outputting light at a second frequency different from the first frequency can include a sample comprised of complexes of free charged biomolecules from an aqueous solution and the bound biomolecules, wherein the bound biomolecules can be bound to respective surfaces of a plurality of polymer beads. Optionally, the sample can include linkers associated with each complex.

In various embodiments of the disclosed subject matter, a method is provided for optimizing sample constituents. The method can include systematically varying the size of one or more of polymer beads, their solution density, composition, the effects of these various factors on different concentrations of analyte, the effects of these various factors on different interface densities of bound molecules, and linkers, as well as detecting a second order component from the sample. The method can further repeat the aforementioned steps to optimize sample constituents. Optionally, a third order component of the sample can be detected.

In an embodiment of the disclosed subject matter, a self-contained apparatus for determining an affinity constant comprises a laser to emit light at a first frequency; an optical element to output light at a second frequency different from the first frequency; a detection element to detect the output light at the second frequency; and a processor to determine an affinity constant of a molecular bond upon which the light at the first frequency was shone. The optical element can be one of a monochromator and a filter. Optionally, the optical element can pass only signals of the second frequency. The apparatus can also include an output element to display data associated with the determined affinity constant.

Having now described embodiments of the disclosed subject matter, it should be apparent to those skilled in the art that the foregoing is merely illustrative and not limiting, having been presented by way of example only. Numerous modifications and other embodiments (e.g., combinations, rearrangements, etc.) are within the scope of one of ordinary skill in the art and are contemplated as falling within the scope of the disclosed subject matter and any equivalents thereto. It can be appreciated that variations to the disclosed subject matter would be readily apparent to those skilled in the art, and the disclosed subject matter is intended to include those alternatives. Further, since numerous modifications will readily occur to those skilled in the art, it is not desired to limit the disclosed subject matter to the exact construction and operation illustrated and described, and accordingly, all suitable modifications and equivalents may be resorted to, falling within the scope of the disclosed subject matter.

1. A non-linear spectroscopic method of measuring an affinity constant without labeling, the method comprising:
providing a plurality of free, charged biomolecules in an aqueous solution;
providing a plurality of bound biomolecules, the bound biomolecules being bound to respective surfaces of a plurality of polymer beads;
complexing the free charged biomolecules with the bound biomolecules;
probing the complexed biomolecules using second harmonic generation (“SHG”);
detecting a change in a net electric charge for solid/aqueous interfaces associated with the complexed biomolecules based on an SHG signal received from the solution; and
determining an affinity constant of the complexed biomolecules based on said detecting.

2. The method of claim 1, wherein said determining includes comparing a detected net electric charge with a previously detected net electric charge.

3. The method of claim 1, wherein the plurality of bound biomolecules are charged.

4. The method of claim 1, wherein the plurality of bound biomolecules are neutral.

5. The method of claim 1, wherein the free charged biomolecules have a first negative charge, and the bound biomolecules have a second negative charge.

6. The method of claim 5, wherein the first and second negative charges are the same.

7. The method of claim 1, further comprising quantifying a maximum number of complexing biomolecules based on said determining the affinity constant.

8. The method of claim 1, wherein the charged biomolecules are one of a protein, DNA, and RNA, and the bound molecules are one of a protein, DNA, and RNA.

9. The method of claim 1, further comprising:
providing a second plurality of free biomolecules in the aqueous solution;
providing a second plurality of bound biomolecules;
complexing the second free biomolecules with the second bound biomolecules; and
selectively probing the first complexed biomolecules using second harmonic generation (“SHG”) in the presence of the second complexed biomolecules.

10. The method of claim 1, wherein the determined affinity constant is used for one of drug discovery, for drug design, to investigate diseases and develop diagnostic methods at the biomolecular level, and for DNA sequencing.

11. The method of claim 1, wherein 9 ng or less of the free, charged biomolecules is provided.

12. The method of claim 1, further comprising measuring time-dependent processes associated with said complexing.

13-26. (canceled)

27. A system comprising:
means for providing light at a first frequency;
means for outputting light at a second frequency different from the first frequency, said means for outputting including a sample of complexed molecules in an aqueous solution;
means for detecting the light at the second frequency; and
means for determining an affinity constant of complexed molecules at a solid/aqueous interface based on an output signal received from said means for detecting,
wherein said means for providing light illuminates said means for outputting light with light at the first frequency.

28. The system of claim 27, wherein said means for outputting includes means for filtering out frequencies other than the second frequency.

29. The system of claim 27, wherein said means for providing light includes a laser.

30-39. (canceled)

40. A method for detecting a change in net electric charge at a solid/water interface when free molecules from a medium complex with bound molecules that are bound to the solid side of the interface, the method comprising illuminating a complex formed by the bound and free molecules with light of a first frequency and capturing second harmonic light generated by an electric field near the complex; determining from the intensity of the second harmonic light, a characteristic of the complex.

41. The method of claim 40, further comprising generating an output to a display device responsively to a result of the determining.

42. The method of claim 40, wherein the medium is an aqueous medium.

43. The method of claim 40, wherein the Free molecule is a biomolecule.

44. The method of claim 40, wherein the bound molecule is a biomolecule.

45-55. (canceled)
